(19) United States
(12) Patent Application Publication
(10) Pub. No.: US 2008/0298901 A1
(43) Pub. Date: Dec. 4, 2008

(54) Soil Consolidating Method and Composition Therefor

(76) Inventors: Jean-Pierre Hamelin, Nanterre (FR); Gerard Evers, Nanterre (FR); Sabine Darson-Balleur, Nanterre (FR)

Correspondence Address: KENYON & KENYON LLP, 1500 K STREET N.W., SUITE 700, WASHINGTON, DC, 20005, US

(21) Appl. No.: 11/632,551

(22) PCT Filed: Jul. 26, 2005
(86) PCT No.: PCT/FR2005/050619

§ 371 Date: Jan. 29, 2007

(30) Foreign Application Priority Data
Jul. 28, 2004 (FR) 0451685

(51) Int. Cl. C09K 17/14

(52) U.S. Cl. 405/264

(57) ABSTRACT

The invention relates to a soil consolidation process using a combination of calcifying bacteria and denitrifying bacteria.

The invention further relates to a composition for carrying out said process.

The invention relates to a soil consolidation process and to a composition for carrying out said process.

Fine or liquefiable soils have a very low permeability in the order of 10⁻⁵ m/s. Consolidating such soils or rendering them impervious involves the injection of solutions in which the maximum size of the grains they contain must be less than a micron. With this in mind, mineral solutions have been developed which on the other hand have short setting times, limiting their penetration into the soil and the release of polluting phases such as ammonia or nitrates.

Furthermore, the use of calcifying bacteria in the renovation of facings is described in patent applications EP-A-388 404 and FR-A-2 734 261.

The value of calcifying bacteria is that they are capable of penetrating deep into the soils via the culture medium containing them, live there for as long as they are supplied with nutriments, and cause carbonates to grow there on the surface of the grains of soil, maintaining an open porosity if necessary.

It is pointed out in this regard that the idea of using bacteria to “cement” the soil has formed the subject of a study in Australia (cf. www.innovation.wa.gov.au/Innovation/News/2002/07). However, to the Applicant's knowledge, this study has not yet formed the subject of a concrete application.

In pursuit of its researches in this field, the Applicant found that calcifying bacteria produce nitrogen compounds that are thrown out into the surrounding medium. This disadvantage can have adverse consequences on the environment and/or health, e.g. if the soil to be consolidated is located near a water tap connection.

One object of the invention therefore consists in providing a soil consolidation process which respects the environment and/or health.

Another object of the invention consists in providing a process in which the consolidating “cement” does not exhibit a setting phenomenon.

Another object of the invention consists in providing a process which is carried out with fewer constraints than the conventional processes.

These objects are achieved according to the present invention by using a combination of calcifying bacterial solutions and denitrifying bacterial solutions.

Thus, according to a first feature, the invention relates to a soil consolidation process comprising the following steps:
a) the introduction into the soil of one or more solutions of calcifying bacteria;
b) the circulation of this solution (these solutions) in the soil;
c) the introduction into the soil of one or more nutrient solutions for the calcifying bacteria and the circulation of this solution (these solutions) in the soil; and
d) the introduction into the soil of one or more solutions of denitrifying bacteria and the circulation of this solution (these solutions) in the soil.

“Calcifying bacteria” are understood as meaning bacteria which make carbonates or cause them to grow. These bacteria are also known as carbonatogenic bacteria (cf. patent application FR-A-2 734 261 in particular).

The bacteria belonging to the following families may be mentioned as examples of calcifying bacteria that can be used in the process of the invention:
Bacillaceae (preferably of the genus Bacillus, e.g. Bacillus cereus, Bacillus pasteurii, etc.),
Pseudomonadaceae (preferably of the genus Pseudomonas, e.g. Pseudomonas stutzerii, etc.),
Enterobacteriaceae (preferably of the genus Proteus, e.g. Proteus mirabilis, etc.),
Myxococcales (preferably of the genus Myxococcus, e.g. Myxococcus xanthus, etc.).

“Denitrifying bacteria” are understood as meaning soil bacteria that convert nitric nitrogen to molecular nitrogen and ammonia.

The following bacteria may be mentioned as examples of denitrifying bacteria that can be used in the process of the invention:
Pseudomonas denitrificans,
Azospirillum brasilense,
Pseudoxanthomonas broegbernesis,
Luteimonas mephitis,
Stenotrophomonas nitritireducens,
Thermomonas brevis or Thermomonas fusca,
Nitratireductor aquibiodomus.

“Solution of bacteria” (or bacterial solution) shall be understood as meaning that the bacteria are in solution in an appropriate culture medium in an amount of about 10⁶ to about 10⁹ cells/ml.

An example of a culture medium for calcifying bacteria and an example for denitrifying bacteria are given below by way of indication:
Culture medium for calcifying bacteria
   0.01 M phosphate buffer of pH 6.5
   1% (w/v) casitone
   0.1% (w/v) MgSO₄.7H₂O
Culture medium for denitrifying bacteria
   1000 ml of distilled water
   5 g of peptone
   3 g of meat extract

Each medium is sterilized in an autoclave for 20 min at 121° C. After cooling, it is inoculated with the above bacteria.

The first step of the process according to the invention consists in introducing one or more solutions of calcifying bacteria into the soil which it is desired to consolidate.

Care will have been taken beforehand to provide the following on the site to be treated:
on the one hand feed borings, preferably located on the perimeter of the zone to be consolidated, and
on the other hand pumping or recovery borings (e.g. wellpoints), preferably located at the center of the zone to be consolidated.

This network of feed and recovery borings (which will also be called “blasting plan” hereafter) is designed so that the flow of fluids can be delimited only to the volume of soil to be treated. As a general rule, the number and position of the feed and recovery borings is determined so that the time required to replace the total volume of water (naturally present in the soil) in the zone to be consolidated does not exceed half the practical life of the bacteria in their culture medium.

The calcifying bacteria are therefore injected into the soil, by gravity, through the feed borings. The recovery borings (e.g. wellpoints) are then used to create a pressure reduction in the zone to be treated. Typically, the recovery systems operate under vacuum at a maximum pressure of −0.7 bar. The effect of the pressure reduction established in this way is to circulate the bacterial solution(s) in the zone to be treated and drive out the water present in the soil, thereby “leaching” the soil. Obviously, the speed of circulation of the bacterial solution is governed by the permeability of the soil, which itself governs the rate and speed of injection of said solution. Circulation is continued until the bacterial solution(s) has (have) filled to the desired level; this level is determined by analyzing the proportion of bacterial solution in the water recovered via the recovery systems.

The calcifying bacteria are then provided with the nutriments necessary to ensure the carbonation of the soil and hence the desired consolidation. The nutrient solution(s) is (are) injected into the soil (still by gravity) through the feed borings, and then circulates (circulate) in the zone to be consolidated according to the principle indicated above, while maintaining the pressure reduction created for circulating the calcifying bacteria. Depending on the nature and volume of the soil to be treated, and on the desired degree of consolidation, it may prove necessary to repeat this step one or more times. The length of time required to attain a satisfactory level of carbonation (through the provision of nutriments) is in the order of 30 to 45 days.

The nutrient solutions are standard solutions well known to those skilled in the art. They provide the calcifying bacteria with a source of organic carbon, nitrogen and other elements essential to their physiological function. It is clearly understood that if several types of calcifying bacteria are used, it may be necessary to use different nutrient solutions in order to satisfy the needs of each type of bacteria.

An example of a nutrient solution for the production of carbonate by the calcifying bacteria is given below by way of indication:
0.01 M phosphate buffer of pH 8
1% (w/v) casitone
1% (w/v) Ca(CH₃COO)₂.4H₂O
0.02% (w/v) K₂CO₃.½H₂O

This solution is sterilized in an autoclave for 20 min at 121° C. and then cooled before use.

When the injection of the nutrient solution(s) has stopped, the calcifying bacteria die, leaving only the original soil which has been carbonated.

As indicated above, when carbonation takes place, the calcifying bacteria produce nitrogen compounds which are thrown out into the surrounding medium.

Denitrifying bacteria are therefore used to “neutralize” these waste products.

The value of the process lies in the fact that the denitrifying bacteria utilize the degradation products of the calcifying bacteria as nutriments for their own metabolism, making the process perfectly ecological.

The solution(s) of denitrifying bacteria is (are) injected into the soil, again through the feed borings, and then circulates (circulate) in the zone to be consolidated by virtue of the pressure reduction created in order to circulate the calcifying bacteria and the nutrient solutions.

In one particular embodiment of the invention, the solution(s) of denitrifying bacteria is (are) injected in step a), simultaneously with or after the injection of the solution(s) of calcifying bacteria.

The process according to the invention can be optimized by using means of monitoring the progress of the treatment so as to adapt it accordingly, such as:
means of analyzing the pumped products and liberated gases,
appropriate geotechnical tests, or geophysical tests.

Thus the change in the degree of carbonation is preferably evaluated by geophysical methods, e.g. by measuring the change in the velocity of the shear waves in the ground between feed borings and pumping or recovery borings.

The proportion of bacteria and/or degradation products of the calcifying bacteria in the water recovered via the recovery systems is also analyzed. If this analysis reveals the presence of nitrogen compounds, e.g. nitrates, it is possible to treat the recovered water with a solution of denitrifying bacteria as defined above. The treated water can then be reinjected into the soil, e.g. into the phreatic water.

Depending on the type of microorganisms used, the process according to the invention makes it possible to preserve the porosity of the ground, which is favorable in certain cases (maintaining the subterranean circulation, which is the specific case of the liquefaction of soils in the event of an earthquake), or conversely to block the pores.

For example, the bacterium Myxococcus xanthus has the following advantages:
it enables a layer of CaCO₃ to be deposited on the wall of the pores without blocking them,
the deposit of calcite is strongly bound to the pre-existing grains of soil,
the new crystals of calcite formed in this way are stronger than the original material,
it is possible to modulate the productivity of the bacteria and the nature of their deposits by modifying their culture medium.

The use of bacterial solutions to consolidate soil offers the following advantages compared with the traditional slurries:
they have similar rheological properties to water, i.e. an excellent ability to penetrate the ground,
they do not exhibit a setting phenomenon, affording them a large radius of action; the borings can therefore be much more widely spaced than those required for a conventional injection treatment.

These two properties allow a high degree of flexibility in the design of the “blasting plan”, which can also be adapted during treatment.

Another advantage associated with the above properties is that implementation of the process does not require special equipment and has fewer constraints than conventional injection (storage of products, preparation-mixing equipment, operation under high pressure, cleaning constraint, etc.).

According to a second feature, the invention relates to a composition for carrying out the process described above. This composition separately contains (i) calcifying bacteria, (ii) denitrifying bacteria and (iii) optionally one or more nutrient solutions for the calcifying bacteria. The bacteria, whether calcifying or denitrifying, are cultivated on-site from lyophilized strains or strains in solution in an appropriate culture medium. The composition can take the form of a two-part or three-part kit, each part containing the appropriate amounts of calcifying and denitrifying bacteria and, if required, nutrient solutions.

The invention will now be described in greater detail with the aid of the Example below, which is given purely by way of illustration.

### EXAMPLE

### Consolidation of the Subsoil of a Building

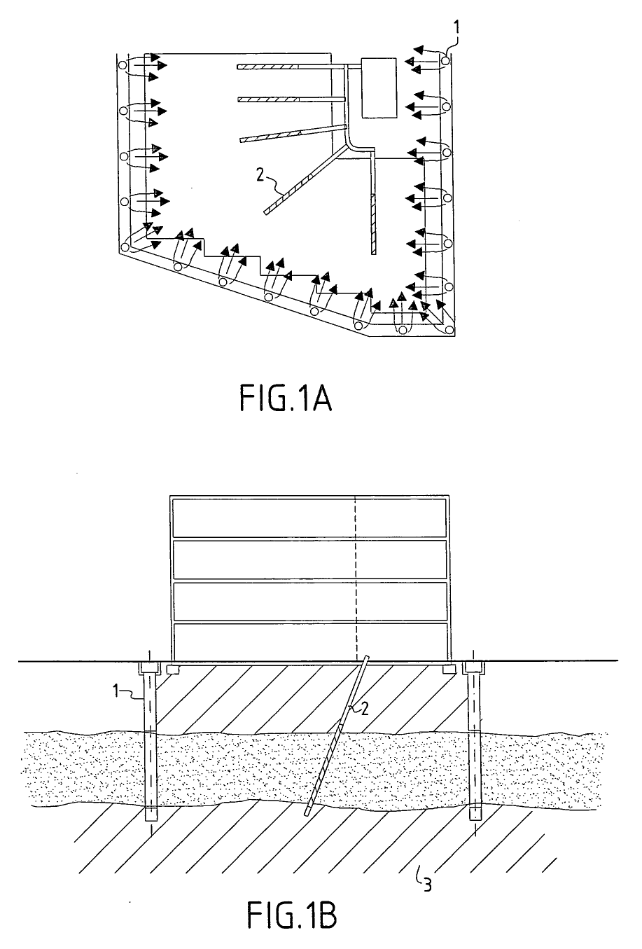

FIGS. 1A and 1B diagrammatically represent the implementation of the process of the invention for treating the soil under an existing building.

FIG. 1A is a bird's eye view of the “blasting plan” (network of feed and recovery borings) used in the process of the invention. More precisely, the blasting plan comprises 18 feed borings 1 located on the perimeter of the zone to be treated, and 5 wellpoints 2 located at the center of the zone to be treated.

FIG. 1B is a cutaway view of the treatment carried out under a building.

The hatched zone 3 represents the area to be consolidated.

In a first stage, the feed borings are supplied with a calcifying bacterial solution, which in this case is a solution of Myxococcus xanthus bacteria in a culture medium containing:
0.01 M phosphate buffer of pH 6.5
1% (w/v) casitone
0.1% (w/v) MgSO₄.7H₂O

The wellpoints located at the center of the zone to be treated are placed under reduced pressure, enabling the bacterial solution to circulate within the zone to be treated. Appropriate analysis of the proportion of bacterial solution in the water recovered via the wellpoints defines the moment at which the solution has filled to the desired level.

The operation is then continued with the introduction of a nutrient solution to favor carbonation by the bacteria, said solution having the following composition:
0.01 M phosphate buffer of pH 8
1% (w/v) casitone
1% (w/v) Ca(CH₃COO)₂.4H₂O
0.02% (w/v) K₂CO₃.½H₂O

During this period the water recovered via the wellpoints is analyzed and treated with denitrifying bacteria as soon as the analysis shows the presence of waste products produced by the calcifying bacteria.

After the carbonation phase the water recovered via the wellpoints is recirculated in closed circuit and treated with denitrifying bacteria until the level reached is compatible with the standards in force.

1. A soil consolidation process comprising the following steps:
a) the introduction into the soil of one or more solutions of calcifying bacteria;
b) the circulation of the one or more solutions of the calcifying bacteria in the soil;
c) the introduction into the soil of one or more nutrient solutions for the calcifying bacteria and the circulation of the one or more nutrient solutions in the soil; and
d) the introduction into the soil of one or more solutions of denitrifying bacteria and the circulation of the one or more solutions of denitrifying bacteria in the soil.

2. The process as claimed in claim 1, wherein the one or more solutions of calcifying bacteria, the one or more solutions of denitrifying bacteria, and the one or more nutrient solutions are introduced by means of a network of feed borings.

3. The process as claimed in claim 2, wherein the feed borings are located on the perimeter of the zone to be consolidated.

4. The process as claimed in claim 1, wherein the one or more solutions of calcifying bacteria, the one or more solutions of denitrifying bacteria, and the one or more nutrient solutions are circulated in the soil by means of a network of pumping or recovery borings.

5. The process as claimed in claim 4, wherein the pumping or recovery borings are located at the center of the zone to be consolidated.

6. The process as claimed in claim 1, further comprising monitoring of the progress of the soil consolidation and/or the analysis of the water recovered via the pumping or recovery borings.

7. The process as claimed in claim 1, wherein the calcifying bacteria are selected from the families Bacillaceae, Pseudomonadaceae, Enterobacteriaceae and Myxococcales.

8. A composition for soil consolidation which separately comprises (i) calcifying bacteria, (ii) denitrifying bacteria and (iii) optionally one or more nutrient solutions for the calcifying bateria.

9. The composition as claimed in claim 8, wherein the calcifying bacteria are selected from the families Bacillaceae, Pseudomonadaceae, Enterobacteriaceae and Myxococcales.

10. The composition as claimed in claim 8, wherein the bacteria are in the form of lyophilized strains or strains in solution in their culture medium.
